(19) United States
(12) Patent Application Publication
(10) Pub. No.: US 2011/0102584 A1
(43) Pub. Date: May 5, 2011

(54) Active Protection and Peace Keeper

(76) Inventor: Chi Hong Le, Liverpool, NY (US)

(21) Appl. No.: 12/610,285

(22) Filed: Oct. 31, 2009

(51) Int. Cl. H04N 7/18

(52) U.S. Cl. 348/143; 348/E07.085

(57) ABSTRACT

Active protection uses of Laser, Infra-red, CCD cameras to form array camera to surveillance surround to protect essential objects.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

### Field of Invention

this invention relates generally to tracking and surveillance cameras that make them become active protection essential objects.

In the commercial only use three sensors: CCD, IR, and Laser to do tracking and surveillance for low moving targets. Here, I make up an array camera network turn from conventional sensors to tracking and surveillance fast moving targets.

### BRIEF SUMMARY OF THE INVENTION

Passive protections are not effective to protect, and waste a lot of energy such tank, armor vehicle. Alternative by using active protection, destroy the harmful object before it creates grave damage. Each type of camera has each own advance: laser is good in detection flying object, tracking, distance measure, and chemical signature. Infra-red is good in detection of hiding object. CCD is good in recognize object.

By combine all information collect from sensors, if object is positive harmful, then destroy it by guide the shooter like gun, missile. If object like water-pipe can make rocket launcher, even launch the rocket, the infra-red sensor pick it up, laser track it, distance, speed, direction, then fire missile, rocket, or rain of bullets to stop it. If explosive bury underground like roadside bomb, laser scan the surface know that surface that disruptive, the same time infra-red pick up unusual the difference temperatures between object and ground. CCD sensor is looking suspicion behaviors of human, when sniper start aim or to draw a gun, then the bullet hit sniper, because the phase array camera is constant 360 degree monitor detection, and tracking suspicion harmful objects.

### BRIEF DESCRIPTION OF THE SEVERAL VIEWS OF THE DRAWING

FIG. 1 is three sensors, Laser, Infra-red, CCD, make up one element of phase array camera.

FIG. 2 is phase array camera consist of many elements to cover 360 degree show sharp like sphere that mount on vehicle.

FIG. 3 is phase array camera mounts to balloon, the surface of balloon use photo-voltage to convert sunlight to electrical, so phase array camera become Peace Keeper operate 24/7 more effective compare to drone operation.

FIG. 4 is a portion of phase array camera, only show one type of sensors.

FIG. 5 is frame sequences of cameras overlap 50% field of view.

### DETAILED DESCRIPTION OF THE INVENTION

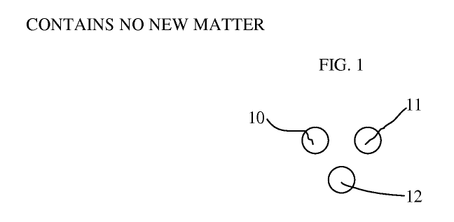

FIG. 1, three sensor cameras to make up one element array in phase array camera, label 10 is Laser, 11 is Infra-red, 12 is CCD. Each of them has 30 degree field of view.

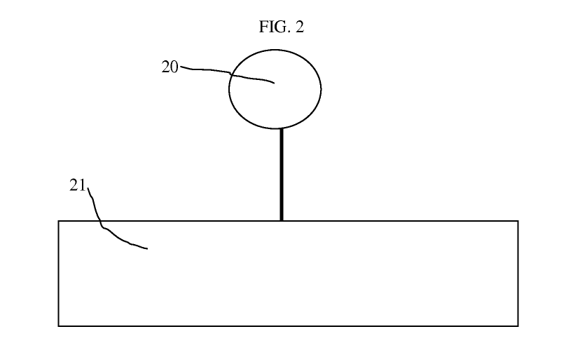

FIG. 2, Phase array camera in sphere sharp mount on vehicle, label 20 is Phase array camera consist of many element of three sensors in FIG. 1, to make up 360 degree field of view, label 21 is vehicle.

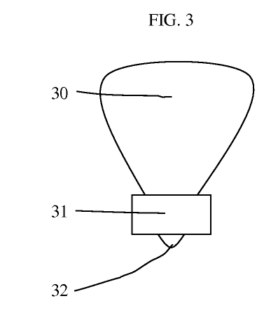

FIG. 3, Peace Keeper operate 24/7, label 30 is a balloon that the outer surface coating photo-voltage to convert sunlight to electrical charging to battery in label 31, here is balloon controller, communication, weapons. Label 32 is phase array camera.

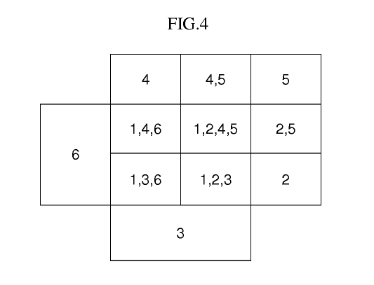

FIG. 4, each sensor has 30 degree field of view in horizon and vertical, and overlap 50%, shown only one type of sensor, shown portion of phase array that make of six of one type of sensor, has one regional field of view 15×15 has four cameras 1,2,4,5, each camera has 30 frame/second→(4)*(30)=120 frame/second for one type of sensor. The phase array cameras have 3 difference type sensors, so in one regional field of view 15×15 has (3 type of sensor)*(4 cameras)*(30 frame/second)=360 frame/second, that is how to turn low speed camera to high speed camera. Use phase shift clock 360/12 =30 degrees, has 12 cameras so each one has phase clock difference 30 degree.

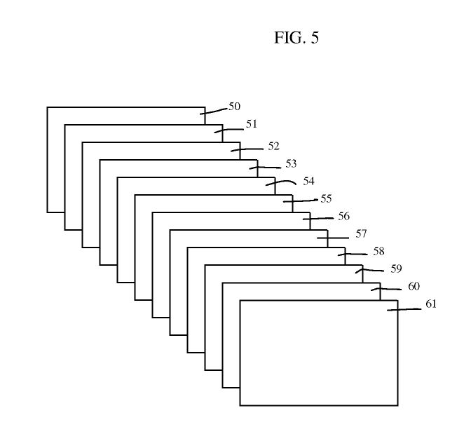

FIG. 5, show frame sequences of regional field of view 15×15 of four cameras 1,2,4,5 in FIG. 4:

Frame (1): label 50 is the first frame of CCD camera 1.

Frame (2): label 51 is the first frame of IR camera 1.

Frame (3): label 52 is the first frame of Laser camera 1.

Frame (4): label 53 is the first frame of CCD camera 2

Frame (5): label 54 is the first frame of IR camera 2.

Frame (6): label 55 is first frame of Laser camera 2.

Frame (7): label 56 is the first frame of CCD camera 4.

Frame (8): label 57 is the first frame of IR camera 4.

Frame (9): label 58 is first frame of Laser camera 4.

Frame (10): label 59 is the first frame of CCD camera 5.

Frame (11): label 60 is the first frame of IR camera 5.

Frame (12): label 61 is first frame of Laser camera 5.

If you watch the Gulf war news, you see the dash of trace bullets. If use the phase camera, we will see the dash gap trace of bullets will reduce by 12. The algorithms to detect and tracking are well defined in academic and commercials. Here, I only talk about to form cameras in array, and read out the frame sequences, make them become active to protect essential objects as troops, vehicles, building.

What I claim as my invention is:

1. Phase array sensor camera to protect essential objects.

2. Peace Keeper operates 24/7.
